(19) United States
(12) Patent Application Publication
(10) Pub. No.: US 2010/0088367 A1
(43) Pub. Date: Apr. 8, 2010

(54) MOBILE WIRELESS COMMUNICATIONS DEVICE AND SYSTEM PROVIDING DYNAMIC MANAGEMENT OF CARRIER APPLICATIONS AND RELATED METHODS

(75) Inventors: Michael W. Brown, Mississauga (CA); Orlin Vesselinov Stoev, Mississauga (CA)

Correspondence Address: Allen, Dyer, Doppelt, Milbrath & Gilchrist - RIM, 255 S. Orange Avenue, Suite 1401, Orlando, FL, 32801, US

(73) Assignee: Research In Motion Limited, Waterloo (CA)

(21) Appl. No.: 12/465,107

(22) Filed: May 13, 2009

Related U.S. Application Data
(60) Provisional application No. 61/103,764, filed on Oct. 8, 2008.

(51) Int. Cl. G06F 15/16; H04M 3/42

(52) U.S. Cl. 709/203; 455/414.1

(57) ABSTRACT

A mobile wireless communications system may include a mobile wireless communications device(s) configured to wirelessly communicate via a carrier network, and a application storage server(s) configured to store a plurality of mobile device applications for use by the mobile wireless communications device(s). The system may further include an application catalog server configured to provide an interface for uploading at least one mobile device application identification file from the carrier network identifying approved mobile device applications. The application catalog server may be further configured to generate a list of the approved mobile device applications to be presented on the mobile wireless communications device(s) based upon the at least one mobile device application identification file, and to direct the mobile wireless communications device(s) to the at least one application storage server to download and install a mobile device application selected from the list of approved mobile device applications.

### RELATED APPLICATION

This application is based upon prior filed copending provisional application Ser. No. 61/103,764 filed Oct. 8, 2008, the entire subject matter of which is incorporated herein by reference in its entirety.

### TECHNICAL FIELD

The present disclosure relates to the field of communications systems, and, more particularly, to mobile wireless communications systems and related methods.

### BACKGROUND

Cellular communications systems continue to grow in popularity and have become an integral part of both personal and business communications. Cellular telephones allow users to place and receive voice calls most anywhere they travel. Moreover, as cellular telephone technology has increased, so too has the functionality of cellular devices and the different types of devices available to users. For example, many cellular devices now incorporate personal digital assistant (PDA) features such as calendars, address books, task lists, etc. Moreover, such multi-function or “smart” devices may also allow users to wirelessly send and receive electronic mail (email) messages and access the Internet via a cellular network and/or a wireless local area network (WLAN), for example.

Mobile devices such as smart phones are also capable of running relatively sophisticated applications, such as games, document processing applications, chat or instant messaging applications, etc. As a result, it may be desirable to provide enhanced approaches for accessing and managing applications for mobile devices, especially as new applications continue to be developed and become available.

### BRIEF DESCRIPTION OF THE DRAWINGS

For a better understanding of the various embodiments described herein and to show more clearly how they may be carried into effect, reference will now be made, by way of example only, to the accompanying drawings which show at least one example embodiment and in which:

FIG. 1 is a schematic block diagram of a mobile wireless communications system in accordance with one embodiment;

FIGS. 2 and 3 are flow diagrams illustrating mobile wireless communications method aspects in accordance with various embodiments;

FIGS. 4-6 are schematic block diagrams of various exemplary implementations of the system of FIG. 1;

FIG. 7 is a schematic block diagram of an exemplary embodiment of a mobile device that may be used with the system of FIG. 1;

FIG. 8 is a schematic block diagram of an exemplary embodiment of a communication subsystem component of the mobile device of FIG. 7;

FIG. 9 is an exemplary block diagram of a node of a wireless network; and

FIG. 10 is a schematic block diagram illustrating components of a host system in one exemplary configuration for use with the wireless network of FIG. 9 and the mobile device of FIG. 7.

### DETAILED DESCRIPTION

The present description is made with reference to the accompanying drawings, in which exemplary embodiments are shown. However, many different exemplary embodiments may be used, and thus the description should not be construed as limited to the exemplary embodiments set forth herein. Rather, these exemplary embodiments are provided so that this disclosure will be thorough and complete. Like numbers refer to like elements throughout, and prime and double prime notation is used to indicate similar elements or steps in different embodiments.

In addition, numerous specific details are set forth in order to provide a thorough understanding of the example embodiments described herein. However, it will be understood by those of ordinary skill in the art that the exemplary embodiments described herein may be practiced without these specific details. In other instances, well-known methods, procedures and components have not been described in detail so as not to obscure the exemplary embodiments described herein. Also, the description is not to be considered as limiting the scope of the example embodiments described herein.

Generally speaking, a mobile wireless communications system is set forth herein which may include at least one mobile wireless communications device configured to wirelessly communicate via a carrier network, and at least one application storage server configured to store a plurality of mobile device applications for use by the at least one mobile wireless communications device. The system may further include an application catalog server configured to provide an interface for uploading at least one mobile device application identification file from the carrier network identifying approved mobile device applications. The application catalog server may be further configured to generate a list of the approved mobile device applications to be presented on the at least one mobile wireless communications device based upon the at least one mobile device application identification file, and to direct the at least one mobile wireless communications device to the at least one application storage server to download and install a mobile device application selected from the list of approved mobile device applications.

The interface may also be for permitting modification of the at least one mobile device application identification file by the carrier network. Furthermore, the at least one mobile wireless communications device may comprise a plurality thereof having respective device types. As such, the application catalog server may be configured to generate different lists of approved mobile device applications for respective mobile wireless communications device types. In addition, the at least one mobile wireless communications device may be configured to generate an installation report upon installation of the selected mobile device application. Moreover, the application catalog server may be configured to collect the installation report.

By way of example, the at least one application identification file may comprise an extensible markup language (XML) file. Furthermore, the list of the approved mobile device applications may comprise a Really Simple Syndication (RSS) formatted list including a plurality of application descriptors. Moreover, the application descriptors may include at least one of an application name, version, vendor, description, and size.

A related application catalog server may be for use with at least one mobile wireless communications device configured to wirelessly communicate via a carrier network, and at least one application storage server configured to store a plurality of mobile device applications for use by the at least one mobile wireless communications device. The application catalog server may include an interface module configured to provide an interface for uploading at least one mobile device application identification file from the carrier network identifying approved mobile device applications. The application catalog server may further include a processing module configured to generate a list of the approved mobile device applications to be presented on the at least one mobile wireless communications device based upon the at least one mobile device application identification file, and direct the at least one mobile wireless communications device to the at least one application storage server to download and install a mobile device application selected from the list of approved mobile device applications.

A related mobile wireless communications method may include providing at least one mobile wireless communications device configured to wirelessly communicate via a carrier network, and storing a plurality of mobile device applications for use by the at least one mobile wireless communications device on at least one application storage server. Furthermore, at an application catalog server, an interface may be provided for uploading at least one mobile device application identification file from the carrier network identifying approved mobile device applications. Additionally, a list of the approved mobile device applications may be generated to be presented on the at least one mobile wireless communications device based upon the at least one mobile device application identification file, and the at least one mobile wireless communications device may be directed to the at least one application storage server to download and install a mobile device application selected from the list of approved mobile device applications.

A physical computer-readable medium is also provided for use with at least one mobile wireless communications device that is configured to wirelessly communicate via a carrier network, and at least one application storage server configured to store a plurality of mobile device applications for use by the at least one mobile wireless communications device. The computer-readable medium may include an interface module configured to provide an interface for uploading at least one mobile device application identification file from the carrier network identifying approved mobile device applications. A processing module may also be configured to generate a list of the approved mobile device applications to be presented on the at least one mobile wireless communications device based upon the at least one mobile device application identification file, and direct the at least one mobile wireless communications device to the at least one application storage server to download and install a mobile device application selected from the list of approved mobile device applications.

Mobile wireless communications device application management systems and methods are described herein for providing enhanced functionality with respect to software applications for the devices. The exemplary embodiments described herein may be used with mobile wireless communication devices, hereafter referred to as mobile devices, which can be configured according to an IT policy. It should be noted that the term IT policy, in general, refers to a collection of IT policy rules, in which the IT policy rules can be defined as being either grouped or non-grouped and global or per-user. The terms grouped, non-grouped, global and per-user are defined further below. Examples of applicable communication devices include pagers, cellular phones, cellular smart-phones, wireless organizers, personal digital assistants, computers, laptops, handheld wireless communication devices, wirelessly enabled notebook computers and the like.

The mobile device is a two-way communication device with advanced data communication capabilities including the capability to communicate with other mobile devices or computer systems through a network of transceiver stations. The mobile device may also have the capability to allow voice communication. Depending on the functionality provided by the mobile device, it may be referred to as a data messaging device, a two-way pager, a cellular telephone with data messaging capabilities, a wireless Internet appliance, or a data communication device (with or without telephony capabilities).

Generally speaking, it may be desirable to allow carriers to have a central place on a mobile device to market and make available applications of their choosing, and to be able to dynamically change this content at any time. This may be seen as a more robust replacement for carrier virtual pre-loads (VPLs). More particularly, a VPL is an existing mechanism where a service book can be pushed to devices that will result in an application download icon being placed on the device's ribbon (if the application is not already installed). When the icon is clicked, the device browser is opened to a download page for the particular application. Some of the drawbacks to this approach are that it requires a separate service book for each application, that it may clutter the device's ribbon when many VPLs are pushed, and that it may be hard for a user to immediately distinguish a true application icon from a VPL icon.

As will be discussed further below, Research in Motion Limited (RIM) hosts a server in a network operating center (NOC) which contains lists of applications per carrier/device type/OS version. These lists are stored as XML files, for example.

In accordance with one embodiment, carriers may make requests to add applications to the lists by providing details to RIM about the application including, for example, name, vendor, version, text description, icon, marketing image, and links to the application binaries (which may not necessarily be hosted by RIM). The application details are entered into an editor utility which generates the XML files to be hosted. The lists are published to the RIM hosted server in the NOC using a server publishing utility. These steps are done by RIM. Service books are pushed to devices, which specify the base URL location of the RIM hosted server. Part of the base URL includes the name of the carrier.

The device appends its device type and OS version to the base URL when it downloads the XML files from the server so that it gets the appropriate list. The device presents the list of applications to the user in a central UI application, from which the user is able to invoke the installation of selected applications. The device may check for updates to the list automatically at a given interval if enabled, or manually as requested by the user, allowing additions or changes to the list to be propagated from the server to the device.

By way of contrast, other typical mobile device application approaches do not allow for control by carriers, rather they either make available single vendor applications (e.g., Google™ Mobile Updater), or arbitrary third party applications submitted by developers themselves (e.g., Handango InHand, iPhone App Store, etc.).

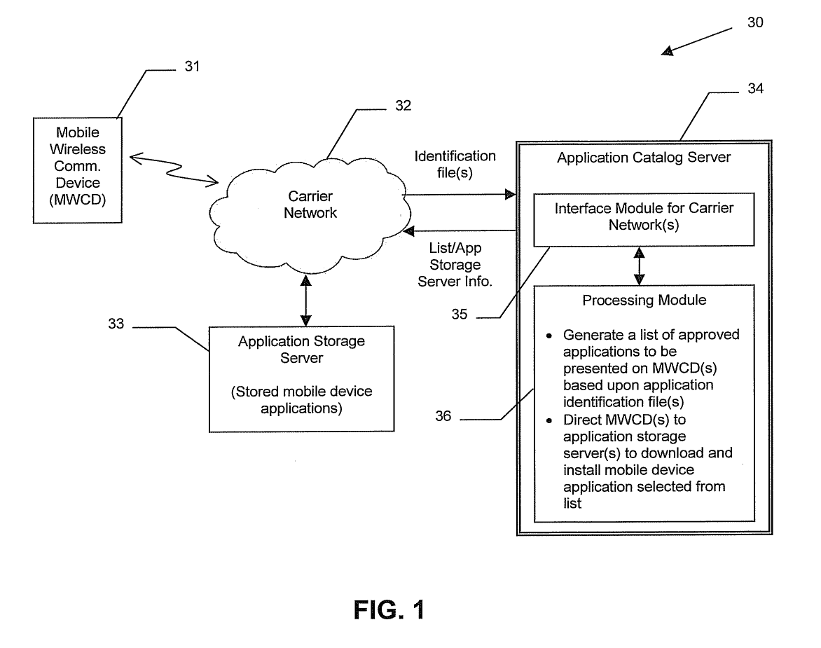

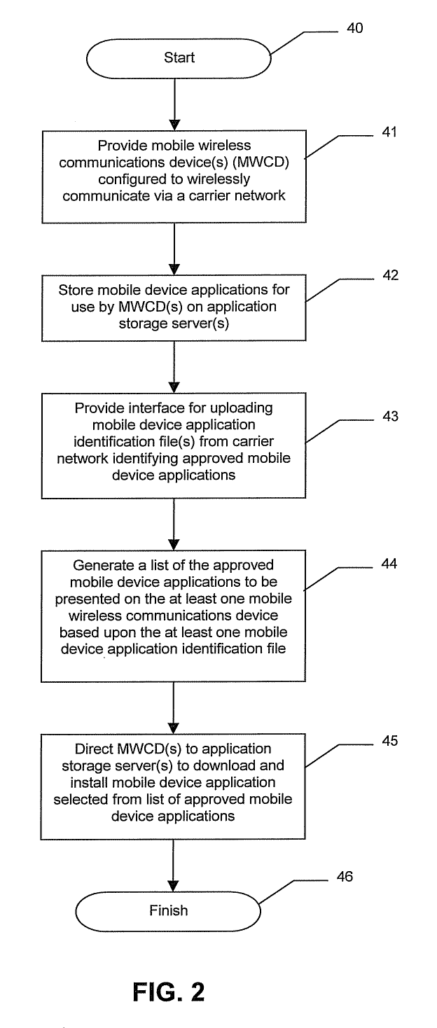

Turning more particularly to FIGS. 1-2, a mobile wireless communications system 30 and associated method aspects are first described. Beginning at Block 40, one or more mobile wireless communications devices 31, such as those noted above, are configured to wirelessly communicate via a carrier network 32 (e.g., a cellular network), at Block 41. One or more application storage servers 33 are configured to store a plurality of mobile device applications for use by the mobile wireless communications device 31, at Block 42. Moreover, an application catalog server 34 is configured to provide an interface or interface module 35 for uploading one or more mobile device application identification files from the carrier network 32 identifying approved mobile device applications, at Block 43. This advantageously allows the carrier to add new applications that it wants to make available for the mobile device, as will be discussed further below.

The application catalog server 34 may further include a processor or processing module 36 configured to generate a list of the approved mobile device applications to be presented on the mobile wireless communications device 31 based upon the application identification file(s), at Block 44, and to direct the mobile wireless communications device to the application storage server 33 to download and install a mobile device application selected from the list of approved mobile device applications, at Block 45, thus concluding the method illustrated in FIG. 2 (Block 46).

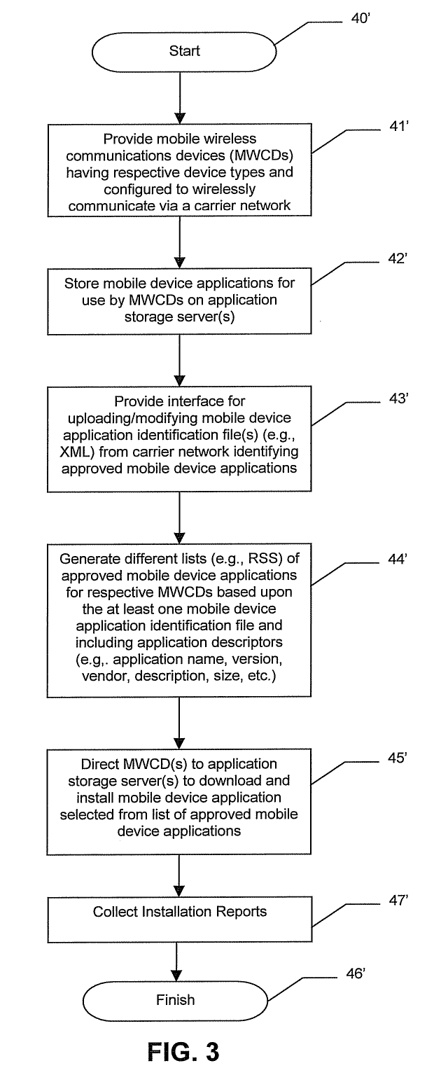

Referring additionally to FIG. 3, the interface module 35 also advantageously permits modification of the mobile device application identification file by the carrier network 32 (Block 43′). Thus, the carrier may advantageously readily publish updated versions of applications, remove old or unsupported applications from the list of approved applications, etc., simply by updating the appropriate application identification file or files. In a cellular network application, it will be appreciated that numerous types of cellular devices from different manufacturers are typically used with a given network. Thus, it is particularly helpful for a carrier to have the ability to readily update application offerings and information as new types of devices are added to the network.

The processing module 36 of the application catalog server 34 may thus advantageously be configured to generate different lists of approved mobile device applications for respective mobile wireless communications device types 31 (Block 44′). For example, different software applications may be designed for different mobile device operating platforms, and thus not be compatible with all device types, or certain applications may have minimum processing processing/memory requirements that are not available on some mobile device types.

In some embodiments, the mobile devices 31 may be configured to generate an installation report upon installation of the selected mobile device application, and the processing module 36 may advantageously be configured to collect the installation report, at Block 47′. As such, the application catalog server 34 provides a convenient centralized location for collecting usage information for the various applications installed across multiple device types, and even across multiple carriers in embodiments where the application catalog server supports multiple networks, as will be appreciated by those skilled in the art.

It should be noted that the application catalog server 34 may collect other application lifecycle reporting information as well, in addition to (or in lieu of) installation events. By way of example, the mobile device 31 may also optionally report on one or more application lifecycle events including upgrades, downgrades, and deletions. Other application lifecycle events may include network, memory, or other usage statistics, for example.

In accordance with one example, the at least one application identification file may comprise an extensible markup language (XML) file (Block 43′), although other suitable file types may also be used. Furthermore, the list of the approved mobile device applications may comprise a Really Simple Syndication (RSS) formatted list including a plurality of application descriptors (Block 44′), though here again other suitable formats may also be used, as will be appreciated by those skilled in the art. Moreover, the application descriptors may include at least one of an application name, version, vendor, description, and size, as will be described further below.

It should be noted that the various components/functions of the application storage server and application catalog server 34 may be implemented using a combination of hardware and software components, and that they may also be implemented using a single server device in some embodiments, or in other embodiments these operations may be distributed across multiple computing devices, as will be appreciated by those skilled in the art. For example, in some embodiments there may be multiple application storage servers that host respective applications from different software developers or vendors, or different carriers. Moreover, in some embodiments the application catalog server may be implemented using a combination of computing devices in a network operating center (NOC), as will be discussed further in the following examples.

The foregoing will be further understood with reference to exemplary implementations thereof now described with reference to the BlackBerry® mobile wireless communications infrastructure. More particularly, a given BlackBerry® device may include application center software module 55 for performing the above-noted mobile device operations, including retrieving updated lists of available applications. In the exemplary implementation, the application catalog server is implemented using one or more application directory servers hosted in the NOC. However, the techniques described herein may be used with other mobile devices and systems, as will be appreciated by those skilled in the art.

The application center 55 is configured on the mobile device 31 via a service book over an available communication channel, e.g., a BlackBerry® Enterprise Server (BES) or the BlackBerry® Internet Service (BIS). Carriers or third party providers may advantageously host the applications, and the carriers may send updates to the application directory server through existing established channels used by VPL. When the BlackBerry® device user accepts the terms and conditions of use, the device will acquire a list of available applications from the application directory server(s).

The retrieved list is an RSS-formatted list of application descriptors containing, for example: application name; version; vendor; brief description; size; an optional browser link (uniform resource locator, URL) pointing to detailed application information; a URL pointing to the application binaries hosted by the carrier; a URL pointing to an image location that will provide additional marketing and/or pricing information about the application; and a second URL for a smaller image for the application icon.

The main application screen displayed on the device by the application center 55 may advantageously provide the user with a list of applications available for installation provided by the particular carrier for the specific device model and handheld software version. Incompatible applications need not be displayed, and there may be separate lists hosted on the application development server per device model and handheld software version. The main screen will provide the user with the ability to browse the application list, and view the available information about each application in a detailed application screen. The detailed application screen displays a marketing image and opens a browser link, if available, that displays a detailed information page for that application. The application center 55 monitors for installed applications, and detects when an application that is in the list is installed on the device. It reports such events to the application directory server for logging purposes. Installation of other applications not available in the list are not reported, although they may be in some embodiments.

A description of exemplary application directory content is now provided. The application directory includes a set of static application listings. Application listings may be accessed by the application center 55 on BlackBerry® devices based on information such as carrier, device model, operating system (OS) version, etc. Application listings may be grouped for carriers. The application listings may be prepared and published by the application directory administrator based on approved requests from carriers. An Application Listing is a list of application information for particular query criteria, such as carrier, device model, OS version, locale, etc. An application listing will be presented to the application center in a standardized format, such as an XML format (ATOM 1.0) upon request. An exemplary application listing is set forth at the end of the detailed description. The application information in the application listing may include the following properties, for example: application name; vendor; size; version; application description; URL to application bundle for installation; URL to additional information (price, etc.); URL to static application image (may be a relative path); URL to application icon image (may be a relative path); optional application categories; optional language; wireless access protocol (WAP) download; mandatory status (i.e., whether an application is mandatory, in which case an auto-load will be required by the device); and a value add application. However, not all of the above need be used in all implementations, and other information may also be included in some embodiments.

The application center 55 accesses the application directory for application listings for a specific carrier, device mode, OS version, and other information. The application directory returns the application listing for specific query criteria. The application center 55 may present the application listing to the user via the device 56 for application installation selection. The application center 55 will download the application for installation from the carrier or third party provider sites/servers upon selection or request by the user.

The application directory may advantageously host the most current application listings in pre-prepared XML files under certain directory structures. The application directory may optionally maintain the history of content changes. Manual maintenance to the directory content may be performed, particularly before new content is published.

The application directory may be hosted and maintained by an administrator. Moreover, application listings may be published to the application directory by the administrator. By way of example, carriers may provide a document for approval through preset channels. Upon approval, the document will be provided to the administrator to create, delete, and/or update application listings. Application directory administrators may prepare or update application listings upon carriers' requests, or this may be done directly by the carriers through a Web interface, for example. The administrator may edit the listings manually, or may use a utility to generate them. The new set of application listings is then published to the application directory.

The application directory may host application listings in static as well as dynamic files. An exemplary application directory structure may be provided as follows under an application directory root in a Web Server:

```
/ac (Application Directory root)
      /<Carrier Name> (Carrier root)
          /<Country code> (Optional)
                /<listing category, such as data plan>
                    /<Device Model>
                          /<OS Version>
                          /directory.xml (static
                              Application Listing
                              file)
                          /images/ (image root for the
                              Application Listing)
                          /icons/ (icon root for the
                              Application Listing)
```

An offline application directory management utility may be provided to help the application directory administrator prepare content according to the application directory structure. The utility may support such functions as: carrier additions; opening application listings for a carrier; creating a new listing for a device model; adding an application to an application listing; removing an application from the application listing; updating an application in the application listing; preparing publishing files, etc. The application directory administrator may advantageously be able to change the application listings content in the application directory using a programmatic, testable method (as opposed to a manual approach). A Web based application directory publishing utility may be provided to support online publishing of directory content. Through the publishing UI, the administrator may be able to upload the new, carrier specific application directory package from the file system and publish it into the directory server. Again, this may be done directly by the carrier as well.

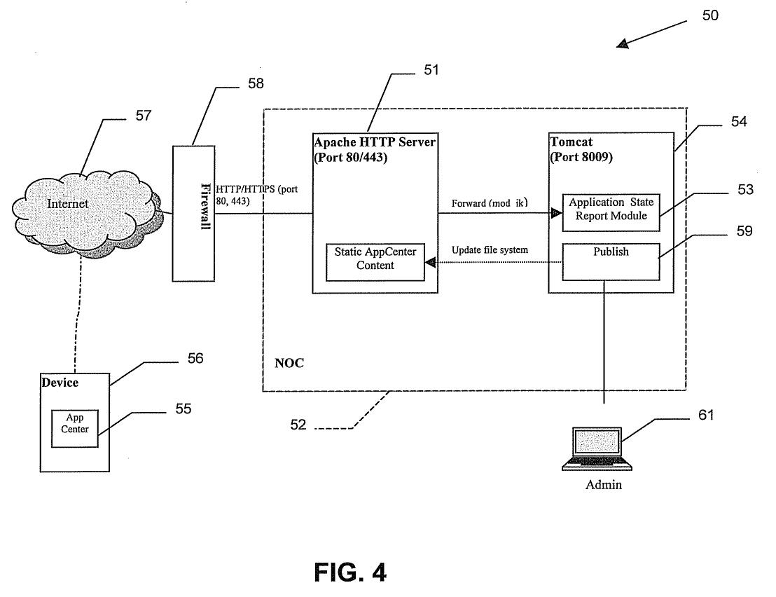

Exemplary application directory deployable components of a system 50 in accordance with a first embodiments are shown in FIG. 4. Static application center (“App Center”) content (application listings for carriers) is deployed in an Apache HTTP server 51 at an NOC 52. The server 51 may be publicly accessible through HTTP/HTTPS protocols as shown. An application state report module 53 is a Web application deployed in an Apache Tomcat server 54. The module 53 accepts or collects application installation reports from the AppCenter 55 on mobile devices 56 through the HTTP protocol via the Internet 57 and a firewall 58, for example. Reporting requests are forwarded from the Apache HTTP Server 51. The application state report module 54 logs reports into daily and size rolling text based log files, for example. The root directory and base name of report files are advantageously configurable.

An application directory publish module 59 is a Web application deployed in the Apache Tomcat server 54. It provides the capability for the application directory administrator to publish the new static AppCenter content deployed in the Apache HTTP Server 51 via an administrator station 61. The administrator may access the application directory publish module 59 from a Web browser via the HTTP protocol, for example. The application directory publish module 59 may be granted write permission to the doc root of static AppCenter content. The application directory publish module 59 may generate a size rolling log file under a configurable location.

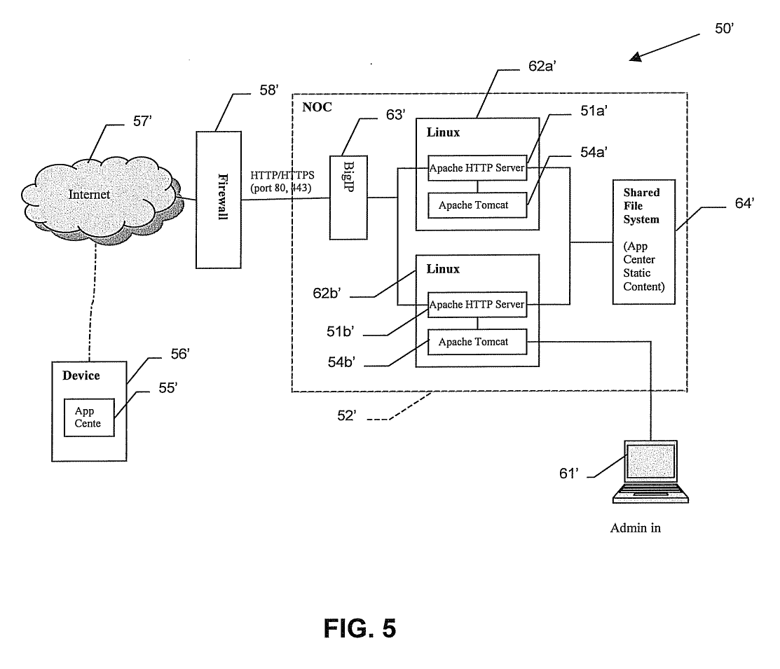

Another deployment configuration is shown in FIG. 5. In this deployment, an Apache HTTP server 51a′ and an Apache Tomcat server 54a′ are installed on a Linux machine 62a′ behind a firewall 58′. The Apache HTTP server 51a′ is listening to ports 80 and 443 and servers for AppCenter 55′ accessing. The Apache Tomcat server 54a′ is listening on port 8009 for Apache/Tomcat integration and is accessible via an intranet. The static AppCenter content may be deployed on the same Linux machine with the Apache HTTP server 51a′ and Apache Tomcat server 54a′ in some embodiments.

However, while a single Linux machine 62a′ may be used, in the illustrated example an Apache HTTP server and cluster file system including additional Linux machines 62b′, etc., is advantageously used to accommodate high load and provide scalability. In this deployment, a homogeneous Apache HTTP Server cluster is configured using a BigIP load balancer 63′. A doc root of a shared file system 64′ including static AppCenter content may be used to point to a desired location in the cluster file system. No specific routing algorithm is required to route HTTP requests from the BigIP load balancer 63′ to a given Apache HTTP server node 51′ in the cluster. However, a round robin configuration may be used, as will be appreciated by those skilled in the art.

Deployment of the Apache Tomcat server 54′ on the same Linux machine 62′ as a corresponding Apache HTTP server 51′ may be helpful in that each Apache HTTP server is forwarding application state report requests to the Apache Tomcat locally. Application publish Web application information may be passed the doc root in the cluster file system to publish new content only once, and may be accessed through a designated node.

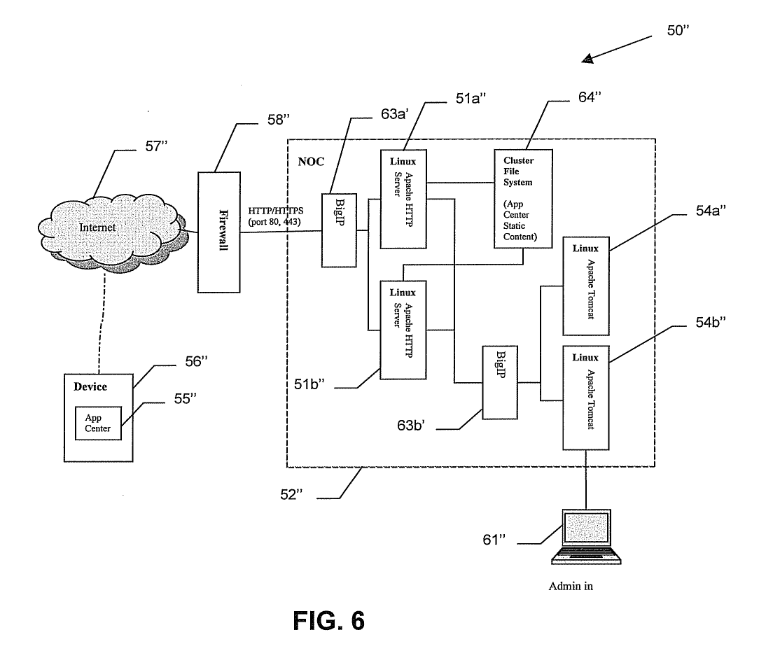

Referring now additionally to FIG. 6, in the event that enhanced scalability is desired, both homogeneous Apache HTTP server clusters and Apache Tomcat server clusters may be configured using a plurality of BigIP load balancers 63a′, 63b′, etc. The Apache HTTP servers 51″ in the cluster may be configured to forward application state report requests to the cluster of Apache Tomcat servers 54″. Application publish Web application information may be passed to the doc root in the cluster file system to publish new content only once, and may be accessed through a designated node.

Another deployment consideration may include monitoring. The application directory server is deployed in the NOC 52, as noted above. Running status of the Apache HTTP server and Apache Tomcat server processes may be monitored. The monitoring service may be provided in the application directory publish module and application state report for monitoring purposes. An exemplary message log format is as follows:
[DateTime] [hostname] [ ]:[Log Level],, [Thread-ID],, [Classname], [Event Description]
   For example:
2008-06-06T13:50:25.798 BCHEN-LT[ ]:DEBUG,,Thread-0,,PingServlet,Application Started.

Another deployment consideration is logging. Application status report log reporting from the AppCenter 55 is performed using daily and size rolling text files. The logging root directory and base filenames are configurable. The logs may be archived periodically. The application directory publish module 59 may log publishing activities. The log file name and location are configurable. The log file may also be archived periodically for debugging purposes. The X.509 format may be used to support HTTPS access to static AppCenter content (application listings) from the AppCenter 55 on the device 56.

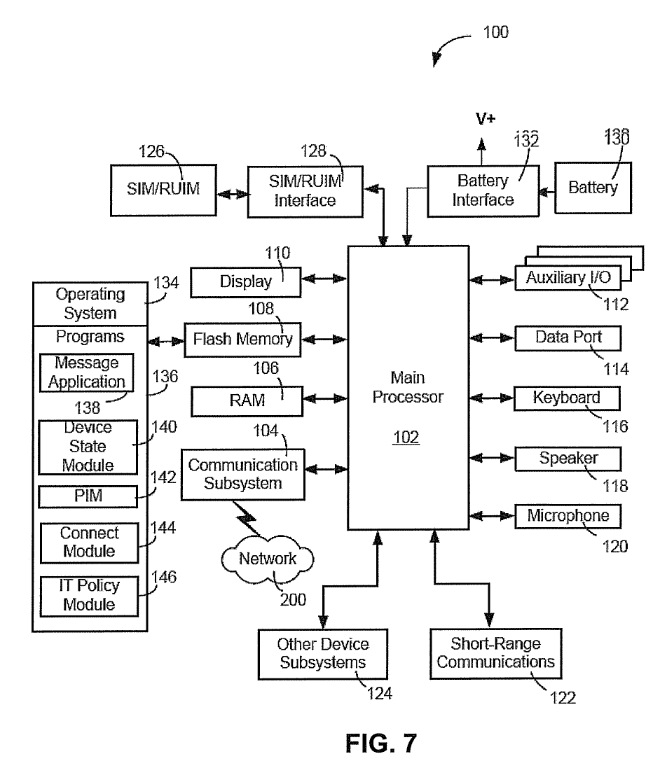

To aid the reader in understanding the structure of the mobile device and how it communicates with other devices and host systems, reference will now be made to FIGS. 7 through 10. Referring first to FIG. 7, shown therein is a block diagram of an example embodiment of a mobile device 100. The mobile device 100 includes a number of components such as a main processor 102 that controls the overall operation of the mobile device 100. Communication functions, including data and voice communications, are performed through a communication subsystem 104. The communication subsystem 104 receives messages from and sends messages to a wireless network 200. In this example embodiment of the mobile device 100, the communication subsystem 104 is configured in accordance with the Global System for Mobile Communication (GSM) and General Packet Radio Services (GPRS) standards. The GSM/GPRS wireless network is used worldwide and it is expected that these standards will be superseded eventually by Enhanced Data GSM Environment (EDGE) and Universal Mobile Telecommunications Service (UMTS). New standards are still being defined, but it is believed that they will have similarities to the network behavior described herein, and it will also be understood by persons skilled in the art that the example embodiments described herein are intended to use any other suitable standards that are developed in the future. The wireless link connecting the communication subsystem 104 with the wireless network 200 represents one or more different Radio Frequency (RF) channels, operating according to defined protocols specified for GSM/GPRS communications. With newer network protocols, these channels are capable of supporting both circuit switched voice communications and packet switched data communications.

Although the wireless network 200 associated with mobile device 100 is a GSM/GPRS wireless network in one example implementation, other wireless networks may also be associated with the mobile device 100 in variant implementations. The different types of wireless networks that may be employed include, for example, data-centric wireless networks, voice-centric wireless networks, and dual-mode networks that can support both voice and data communications over the same physical base stations. Combined dual-mode networks include, but are not limited to, Code Division Multiple Access (CDMA) or CDMA2000 networks, GSM/GPRS networks (as mentioned above), and future third-generation (3G) networks like EDGE and UMTS. Some other examples of data-centric networks include WiFi 802.11, Mobitex™ and DataTAC™ network communication systems. Examples of other voice-centric data networks include Personal Communication Systems (PCS) networks like GSM and Time Division Multiple Access (TDMA) systems.

The main processor 102 also interacts with additional subsystems such as a Random Access Memory (RAM) 106, a flash memory 108, a display 110, an auxiliary input/output (I/O) subsystem 112, a data port 114, a keyboard 116, a speaker 118, a microphone 120, short-range communications 122 and other device subsystems 124.

Some of the subsystems of the mobile device 100 perform communication-related functions, whereas other subsystems may provide “resident” or on-device functions. By way of example, the display 110 and the keyboard 116 may be used for both communication-related functions, such as entering a text message for transmission over the network 200, and device-resident functions such as a calculator or task list.

The mobile device 100 can send and receive communication signals over the wireless network 200 after required network registration or activation procedures have been completed. Network access is associated with a subscriber or user of the mobile device 100. To identify a subscriber, the mobile device 100 requires a SIM/RUIM card 126 (i.e. Subscriber Identity Module or a Removable User Identity Module) to be inserted into a SIM/RUIM interface 128 in order to communicate with a network. The SIM card or RUIM 126 is one type of a conventional “smart card” that can be used to identify a subscriber of the mobile device 100 and to personalize the mobile device 100, among other things. Without the SIM card 126, the mobile device 100 is not fully operational for communication with the wireless network 200. By inserting the SIM card/RUIM 126 into the SIM/RUIM interface 128, a subscriber can access all subscribed services. Services may include: web browsing and messaging such as e-mail, voice mail, Short Message Service (SMS), and Multimedia Messaging Services (MMS). More advanced services may include: point of sale, field service and sales force automation. The SIM card/RUIM 126 includes a processor and memory for storing information. Once the SIM card/RUIM 126 is inserted into the SIM/RUIM interface 128, it is coupled to the main processor 102. In order to identify the subscriber, the SIM card/RUIM 126 can include some user parameters such as an International Mobile Subscriber Identity (IMSI). An advantage of using the SIM card/RUIM 126 is that a subscriber is not necessarily bound by any single physical mobile device. The SIM card/RUIM 126 may store additional subscriber information for a mobile device as well, including datebook (or calendar) information and recent call information. Alternatively, user identification information can also be programmed into the flash memory 108.

The mobile device 100 is a battery-powered device and includes a battery interface 132 for receiving one or more rechargeable batteries 130. In at least some example embodiments, the battery 130 can be a smart battery with an embedded microprocessor. The battery interface 132 is coupled to a regulator (not shown), which assists the battery 130 in providing power V+ to the mobile device 100. Although current technology makes use of a battery, future technologies such as micro fuel cells may provide the power to the mobile device 100.

The mobile device 100 also includes an operating system 134 and software components 136 to 146 which are described in more detail below. The operating system 134 and the software components 136 to 146 that are executed by the main processor 102 are typically stored in a persistent store such as the flash memory 108, which may alternatively be a read-only memory (ROM) or similar storage element (not shown). Those skilled in the art will appreciate that portions of the operating system 134 and the software components 136 to 146, such as specific device applications, or parts thereof, may be temporarily loaded into a volatile store such as the RAM 106. Other software components can also be included, as is well known to those skilled in the art.

The subset of software applications 136 that control basic device operations, including data and voice communication applications, will normally be installed on the mobile device 100 during its manufacture. Other software applications include a message application 138 that can be any suitable software program that allows a user of the mobile device 100 to send and receive electronic messages. Various alternatives exist for the message application 138 as is well known to those skilled in the art. Messages that have been sent or received by the user are typically stored in the flash memory 108 of the mobile device 100 or some other suitable storage element in the mobile device 100. In at least some example embodiments, some of the sent and received messages may be stored remotely from the device 100 such as in a data store of an associated host system that the mobile device 100 communicates with.

The software applications can further include a device state module 140, a Personal Information Manager (PIM) 142, and other suitable modules (not shown). The device state module 140 provides persistence, i.e. the device state module 140 ensures that important device data is stored in persistent memory, such as the flash memory 108, so that the data is not lost when the mobile device 100 is turned off or loses power.

The PIM 142 includes functionality for organizing and managing data items of interest to the user, such as, but not limited to, e-mail, contacts, calendar events, voice mails, appointments, and task items. A PIM application has the ability to send and receive data items via the wireless network 200. PIM data items may be seamlessly integrated, synchronized, and updated via the wireless network 200 with the mobile device subscriber's corresponding data items stored and/or associated with a host computer system. This functionality creates a mirrored host computer on the mobile device 100 with respect to such items. This can be particularly advantageous when the host computer system is the mobile device subscriber's office computer system.

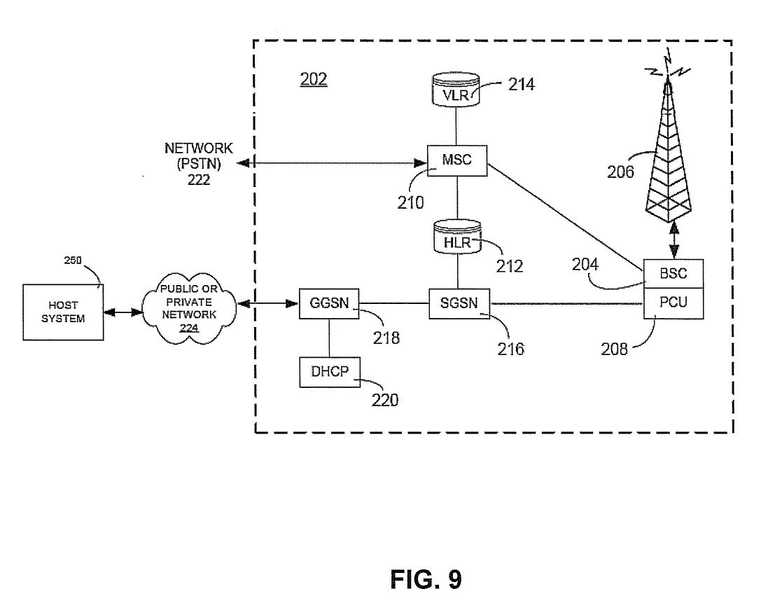

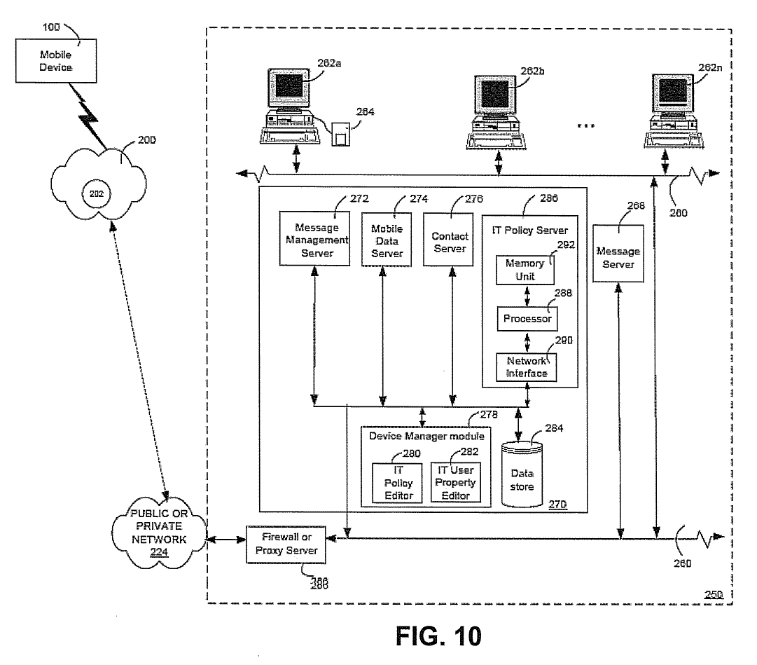

The mobile device 100 also includes a connect module 144, and an IT policy module 146. The connect module 144 implements the communication protocols that are required for the mobile device 100 to communicate with the wireless infrastructure and any host system, such as an enterprise system, that the mobile device 100 is authorized to interface with. Examples of a wireless infrastructure and an enterprise system are given in FIGS. 9 and 10, which are described in more detail below.

The connect module 144 includes a set of APIs that can be integrated with the mobile device 100 to allow the mobile device 100 to use any number of services associated with the enterprise system. The connect module 144 allows the mobile device 100 to establish an end-to-end secure, authenticated communication pipe with the host system. A subset of applications for which access is provided by the connect module 144 can be used to pass IT policy commands from the host system to the mobile device 100. This can be done in a wireless or wired manner. These instructions can then be passed to the IT policy module 146 to modify the configuration of the device 100. Alternatively, in some cases, the IT policy update can also be done over a wired connection.

The IT policy module 146 receives IT policy data that encodes the IT policy. The IT policy module 146 then ensures that the IT policy data is authenticated by the mobile device 100. The IT policy data can then be stored in the flash memory 106 in its native form. After the IT policy data is stored, a global notification can be sent by the IT policy module 146 to all of the applications residing on the mobile device 100. Applications for which the IT policy may be applicable then respond by reading the IT policy data to look for IT policy rules that are applicable.

The IT policy module 146 can include a parser (not shown), which can be used by the applications to read the IT policy rules. In some cases, another module or application can provide the parser. Grouped IT policy rules, described in more detail below, are retrieved as byte streams, which are then sent (recursively, in a sense) into the parser to determine the values of each IT policy rule defined within the grouped IT policy rule. In at least some example embodiments, the IT policy module 146 can determine which applications are affected by the IT policy data and send a notification to only those applications. In either of these cases, for applications that aren't running at the time of the notification, the applications can call the parser or the IT policy module 146 when they are executed to determine if there are any relevant IT policy rules in the newly received IT policy data.

All applications that support rules in the IT Policy are coded to know the type of data to expect. For example, the value that is set for the “WEP User Name” IT policy rule is known to be a string; therefore the value in the IT policy data that corresponds to this rule is interpreted as a string. As another example, the setting for the “Set Maximum Password Attempts” IT policy rule is known to be an integer, and therefore the value in the IT policy data that corresponds to this rule is interpreted as such.

After the IT policy rules have been applied to the applicable applications or configuration files, the IT policy module 146 sends an acknowledgement back to the host system to indicate that the IT policy data was received and successfully applied.

Other types of software applications can also be installed on the mobile device 100. These software applications can be third party applications, which are added after the manufacture of the mobile device 100. Examples of third party applications include games, calculators, utilities, etc.

The additional applications can be loaded onto the mobile device 100 through at least one of the wireless network 200, the auxiliary I/O subsystem 112, the data port 114, the short-range communications subsystem 122, or any other suitable device subsystem 124. This flexibility in application installation increases the functionality of the mobile device 100 and may provide enhanced on-device functions, communication-related functions, or both. For example, secure communication applications may enable electronic commerce functions and other such financial transactions to be performed using the mobile device 100.

The data port 114 enables a subscriber to set preferences through an external device or software application and extends the capabilities of the mobile device 100 by providing for information or software downloads to the mobile device 100 other than through a wireless communication network. The alternate download path may, for example, be used to load an encryption key onto the mobile device 100 through a direct and thus reliable and trusted connection to provide secure device communication.

The data port 114 can be any suitable port that enables data communication between the mobile device 100 and another computing device. The data port 114 can be a serial or a parallel port. In some instances, the data port 114 can be a USB port that includes data lines for data transfer and a supply line that can provide a charging current to charge the battery 130 of the mobile device 100.

The short-range communications subsystem 122 provides for communication between the mobile device 100 and different systems or devices, without the use of the wireless network 200. For example, the subsystem 122 may include an infrared device and associated circuits and components for short-range communication. Examples of short-range communication standards include standards developed by the Infrared Data Association (IrDA), Bluetooth, and the 802.11 family of standards developed by IEEE.

In use, a received signal such as a text message, an e-mail message, or web page download will be processed by the communication subsystem 104 and input to the main processor 102. The main processor 102 will then process the received signal for output to the display 110 or alternatively to the auxiliary I/O subsystem 112. A subscriber may also compose data items, such as e-mail messages, for example, using the keyboard 116 in conjunction with the display 110 and possibly the auxiliary I/O subsystem 112. The auxiliary subsystem 112 may include devices such as: a touch screen, mouse, track ball, infrared fingerprint detector, or a roller wheel with dynamic button pressing capability. The keyboard 116 is preferably an alphanumeric keyboard and/or telephone-type keypad. However, other types of keyboards may also be used. A composed item may be transmitted over the wireless network 200 through the communication subsystem 104.

For voice communications, the overall operation of the mobile device 100 is substantially similar, except that the received signals are output to the speaker 118, and signals for transmission are generated by the microphone 120. Alternative voice or audio I/O subsystems, such as a voice message recording subsystem, can also be implemented on the mobile device 100. Although voice or audio signal output is accomplished primarily through the speaker 118, the display 110 can also be used to provide additional information such as the identity of a calling party, duration of a voice call, or other voice call related information.

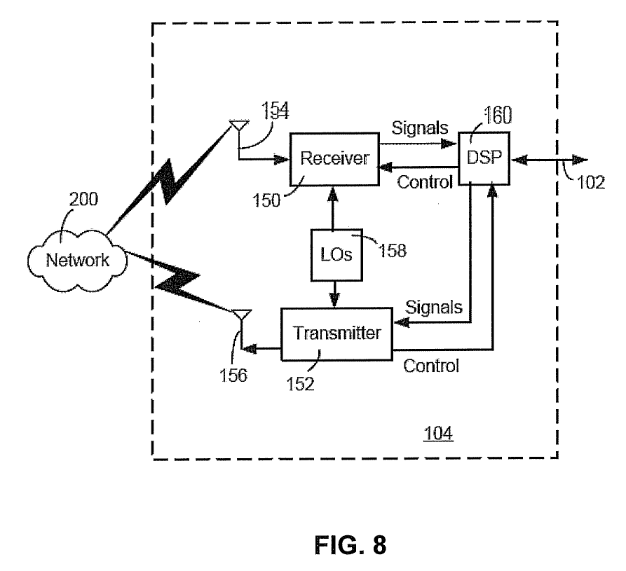

Referring now to FIG. 8, an example block diagram of the communication subsystem component 104 is shown. The communication subsystem 104 includes a receiver 150, a transmitter 152, as well as associated components such as one or more embedded or internal antenna elements 154 and 156, Local Oscillators (LOs) 158, and a processing module such as a Digital Signal Processor (DSP) 160. The particular design of the communication subsystem 104 is dependent upon the communication network 200 with which the mobile device 100 is intended to operate. Thus, it should be understood that the design illustrated in FIG. 8 serves only as one example.

Signals received by the antenna 154 through the wireless network 200 are input to the receiver 150, which may perform such common receiver functions as signal amplification, frequency down conversion, filtering, channel selection, and analog-to-digital (A/D) conversion. A/D conversion of a received signal allows more complex communication functions such as demodulation and decoding to be performed in the DSP 160. In a similar manner, signals to be transmitted are processed, including modulation and encoding, by the DSP 160. These DSP-processed signals are input to the transmitter 152 for digital-to-analog (D/A) conversion, frequency up conversion, filtering, amplification and transmission over the wireless network 200 via the antenna 156. The DSP 160 not only processes communication signals, but also provides for receiver and transmitter control. For example, the gains applied to communication signals in the receiver 150 and the transmitter 152 may be adaptively controlled through automatic gain control algorithms implemented in the DSP 160.

The wireless link between the mobile device 100 and the wireless network 200 can contain one or more different channels, typically different RF channels, and associated protocols used between the mobile device 100 and the wireless network 200. An RF channel is a limited resource that must be conserved, typically due to limits in overall bandwidth and limited battery power of the mobile device 100.

When the mobile device 100 is fully operational, the transmitter 152 is typically keyed or turned on only when it is transmitting to the wireless network 200 and is otherwise turned off to conserve resources. Similarly, the receiver 150 is periodically turned off to conserve power until it is needed to receive signals or information (if at all) during designated time periods.

Referring now to FIG. 9, a block diagram of an example implementation of a node 202 of the wireless network 200 is shown. In practice, the wireless network 200 comprises one or more nodes 202. In conjunction with the connect module 144, the mobile device 100 can communicate with the node 202 within the wireless network 200. In the example implementation of FIG. 9, the node 202 is configured in accordance with General Packet Radio Service (GPRS) and Global Systems for Mobile (GSM) technologies. The node 202 includes a base station controller (BSC) 204 with an associated tower station 206, a Packet Control Unit (PCU) 208 added for GPRS support in GSM, a Mobile Switching Center (MSC) 210, a Home Location Register (HLR) 212, a Visitor Location Registry (VLR) 214, a Serving GPRS Support Node (SGSN) 216, a Gateway GPRS Support Node (GGSN) 218, and a Dynamic Host Configuration Protocol (DHCP) 220. This list of components is not meant to be an exhaustive list of the components of every node 202 within a GSM/GPRS network, but rather a list of components that are commonly used in communications through the network 200.

In a GSM network, the MSC 210 is coupled to the BSC 204 and to a landline network, such as a Public Switched Telephone Network (PSTN) 222 to satisfy circuit switched requirements. The connection through the PCU 208, the SGSN 216 and the GGSN 218 to a public or private network (Internet) 224 (also referred to herein generally as a shared network infrastructure) represents the data path for GPRS capable mobile devices. In a GSM network extended with GPRS capabilities, the BSC 204 also contains the Packet Control Unit (PCU) 208 that connects to the SGSN 216 to control segmentation, radio channel allocation and to satisfy packet switched requirements. To track the location of the mobile device 100 and availability for both circuit switched and packet switched management, the HLR 212 is shared between the MSC 210 and the SGSN 216. Access to the VLR 214 is controlled by the MSC 210.

The station 206 is a fixed transceiver station and together with the BSC 204 form fixed transceiver equipment. The fixed transceiver equipment provides wireless network coverage for a particular coverage area commonly referred to as a “cell”. The fixed transceiver equipment transmits communication signals to and receives communication signals from mobile devices within its cell via the station 206. The fixed transceiver equipment normally performs such functions as modulation and possibly encoding and/or encryption of signals to be transmitted to the mobile device 100 in accordance with particular, usually predetermined, communication protocols and parameters, under control of its controller. The fixed transceiver equipment similarly demodulates and possibly decodes and decrypts, if necessary, any communication signals received from the mobile device 100 within its cell. Communication protocols and parameters may vary between different nodes. For example, one node may employ a different modulation scheme and operate at different frequencies than other nodes.

For all mobile devices 100 registered with a specific network, permanent configuration data such as a user profile is stored in the HLR 212. The HLR 212 also contains location information for each registered mobile device and can be queried to determine the current location of a mobile device. The MSC 210 is responsible for a group of location areas and stores the data of the mobile devices currently in its area of responsibility in the VLR 214. Further, the VLR 214 also contains information on mobile devices that are visiting other networks. The information in the VLR 214 includes part of the permanent mobile device data transmitted from the HLR 212 to the VLR 214 for faster access. By moving additional information from a remote HLR 212 node to the VLR 214, the amount of traffic between these nodes can be reduced so that voice and data services can be provided with faster response times and at the same time requiring less use of computing resources.

The SGSN 216 and the GGSN 218 are elements added for GPRS support; namely packet switched data support, within GSM. The SGSN 216 and the MSC 210 have similar responsibilities within the wireless network 200 by keeping track of the location of each mobile device 100. The SGSN 216 also performs security functions and access control for data traffic on the wireless network 200. The GGSN 218 provides internetworking connections with external packet switched networks and connects to one or more SGSN's 216 via an Internet Protocol (IP) backbone network operated within the network 200. During normal operations, a given mobile device 100 must perform a “GPRS Attach” to acquire an IP address and to access data services. This requirement is not present in circuit switched voice channels as Integrated Services Digital Network (ISDN) addresses are used for routing incoming and outgoing calls. Currently, all GPRS capable networks use private, dynamically assigned IP addresses, thus requiring the DHCP server 220 connected to the GGSN 218. There are many mechanisms for dynamic IP assignment, including using a combination of a Remote Authentication Dial-In User Service (RADIUS) server and a DHCP server. Once the GPRS Attach is complete, a logical connection is established from a mobile device 100, through the PCU 208, and the SGSN 216 to an Access Point Node (APN) within the GGSN 218. The APN represents a logical end of an IP tunnel that can either access direct Internet compatible services or private network connections. The APN also represents a security mechanism for the network 200, insofar as each mobile device 100 must be assigned to one or more APNs and mobile devices 100 cannot exchange data without first performing a GPRS Attach to an APN that it has been authorized to use. The APN may be considered to be similar to an Internet domain name such as “myconnection.wireless.com”.

Once the GPRS Attach operation is complete, a tunnel is created and all traffic is exchanged within standard IP packets using any protocol that can be supported in IP packets. This includes tunneling methods such as IP over IP as in the case with some IPSecurity (IPsec) connections used with Virtual Private Networks (VPN). These tunnels are also referred to as Packet Data Protocol (PDP) Contexts and there are a limited number of these available in the network 200. To maximize use of the PDP Contexts, the network 200 will run an idle timer for each PDP Context to determine if there is a lack of activity. When a mobile device 100 is not using its PDP Context, the PDP Context can be de-allocated and the IP address returned to the IP address pool managed by the DHCP server 220.

Referring now to FIG. 10, shown therein is a block diagram illustrating components of an example configuration of a host system 250 that the mobile device 100 can communicate with in conjunction with the connect module 144. The host system 250 will typically be a corporate enterprise or other local area network (LAN), but may also be a home office computer or some other private system, for example, in variant implementations. In this example shown in FIG. 10, the host system 250 is depicted as a LAN of an organization to which a user of the mobile device 100 belongs. Typically, a plurality of mobile devices can communicate wirelessly with the host system 250 through one or more nodes 202 of the wireless network 200.

The host system 250 comprises a number of network components connected to each other by a network 260. For instance, a user's desktop computer 262a with an accompanying cradle 264 for the user's mobile device 100 is situated on a LAN connection. The cradle 264 for the mobile device 100 can be coupled to the computer 262a by a serial or a Universal Serial Bus (USB) connection, for example. Other user computers 262b-262n are also situated on the network 260, and each may or may not be equipped with an accompanying cradle 264. The cradle 264 facilitates the loading of information (e.g. PIM data, private symmetric encryption keys to facilitate secure communications) from the user computer 262a to the mobile device 100, and may be particularly useful for bulk information updates often performed in initializing the mobile device 100 for use. The information downloaded to the mobile device 100 may include certificates used in the exchange of messages.

It will be understood by persons skilled in the art that the user computers 262a-262n will typically also be connected to other peripheral devices, such as printers, etc. which are not explicitly shown in FIG. 10. Furthermore, only a subset of network components of the host system 250 are shown in FIG. 10 for ease of exposition, and it will be understood by persons skilled in the art that the host system 250 will comprise additional components that are not explicitly shown in FIG. 10 for this example configuration. More generally, the host system 250 may represent a smaller part of a larger network (not shown) of the organization, and may comprise different components and/or be arranged in different topologies than that shown in the example embodiment of FIG. 10.

To facilitate the operation of the mobile device 100 and the wireless communication of messages and message-related data between the mobile device 100 and components of the host system 250, a number of wireless communication support components 270 can be provided. In some implementations, the wireless communication support components 270 can include a message management server 272, a mobile data server 274, a contact server 276, and a device manager module 278. The device manager module 278 includes an IT Policy editor 280 and an IT user property editor 282, as well as other software components for allowing an IT administrator to configure the mobile devices 100. In an alternative example embodiment, there may be one editor that provides the functionality of both the IT policy editor 280 and the IT user property editor 282. The support components 270 also include a data store 284, and an IT policy server 286. The IT policy server 286 includes a processor 288, a network interface 290 and a memory unit 292. The processor 288 controls the operation of the IT policy server 286 and executes functions related to the standardized IT policy as described below. The network interface 290 allows the IT policy server 286 to communicate with the various components of the host system 250 and the mobile devices 100. The memory unit 292 can store functions used in implementing the IT policy as well as related data. Those skilled in the art know how to implement these various components. Other components may also be included as is well known to those skilled in the art. Further, in some implementations, the data store 284 can be part of any one of the servers.

In this example embodiment, the mobile device 100 communicates with the host system 250 through node 202 of the wireless network 200 and a shared network infrastructure 224 such as a service provider network or the public Internet. Access to the host system 250 may be provided through one or more routers (not shown), and computing devices of the host system 250 may operate from behind a firewall or proxy server 266. The proxy server 266 provides a secure node and a wireless internet gateway for the host system 250. The proxy server 266 intelligently routes data to the correct destination server within the host system 250.

In some implementations, the host system 250 can include a wireless VPN router (not shown) to facilitate data exchange between the host system 250 and the mobile device 100. The wireless VPN router allows a VPN connection to be established directly through a specific wireless network to the mobile device 100. The wireless VPN router can be used with the Internet Protocol (IP) Version 6 (IPV6) and IP-based wireless networks. This protocol can provide enough IP addresses so that each mobile device has a dedicated IP address, making it possible to push information to a mobile device at any time. An advantage of using a wireless VPN router is that it can be an off-the-shelf VPN component, and does not require a separate wireless gateway and separate wireless infrastructure. A VPN connection can preferably be a Transmission Control Protocol (TCP)/IP or User Datagram Protocol (UDP)/IP connection for delivering the messages directly to the mobile device 100 in this alternative implementation.

Messages intended for a user of the mobile device 100 are initially received by a message server 268 of the host system 250. Such messages may originate from any number of sources. For instance, a message may have been sent by a sender from the computer 262b within the host system 250, from a different mobile device (not shown) connected to the wireless network 200 or a different wireless network, or from a different computing device, or other device capable of sending messages, via the shared network infrastructure 224, possibly through an application service provider (ASP) or Internet service provider (ISP), for example.

The message server 268 typically acts as the primary interface for the exchange of messages, particularly e-mail messages, within the organization and over the shared network infrastructure 224. Each user in the organization that has been set up to send and receive messages is typically associated with a user account managed by the message server 268. Some example implementations of the message server 268 include a Microsoft Exchange™ server, a Lotus Domino™ server, a Novell Groupwise™ server, or another suitable mail server installed in a corporate environment. In some implementations, the host system 250 may comprise multiple message servers 268. The message server 268 may also be adapted to provide additional functions beyond message management, including the management of data associated with calendars and task lists, for example.

When messages are received by the message server 268, they are typically stored in a data store associated with the message server 268. In at least some example embodiments, the data store may be a separate hardware unit, such as data store 284, that the message server 268 communicates with. Messages can be subsequently retrieved and delivered to users by accessing the message server 268. For instance, an e-mail client application operating on a user's computer 262a may request the e-mail messages associated with that user's account stored on the data store associated with the message server 268. These messages are then retrieved from the data store and stored locally on the computer 262a. The data store associated with the message server 268 can store copies of each message that is locally stored on the mobile device 100. Alternatively, the data store associated with the message server 268 can store all of the messages for the user of the mobile device 100 and only a smaller number of messages can be stored on the mobile device 100 to conserve memory. For instance, the most recent messages (i.e. those received in the past two to three months for example) can be stored on the mobile device 100.

When operating the mobile device 100, the user may wish to have e-mail messages retrieved for delivery to the mobile device 100. The message application 138 operating on the mobile device 100 may also request messages associated with the user's account from the message server 268. The message application 138 may be configured (either by the user or by an administrator, possibly in accordance with an organization's information technology (IT) policy) to make this request at the direction of the user, at some pre-defined time interval, or upon the occurrence of some pre-defined event. In some implementations, the mobile device 100 is assigned its own e-mail address, and messages addressed specifically to the mobile device 100 are automatically redirected to the mobile device 100 as they are received by the message server 268.

The message management server 272 can be used to specifically provide support for the management of messages, such as e-mail messages, that are to be handled by mobile devices. Generally, while messages are still stored on the message server 268, the message management server 272 can be used to control when, if, and how messages are sent to the mobile device 100. The message management server 272 also facilitates the handling of messages composed on the mobile device 100, which are sent to the message server 268 for subsequent delivery.

For example, the message management server 272 may monitor the user's “mailbox” (e.g. the message store associated with the user's account on the message server 268) for new e-mail messages, and apply user-definable filters to new messages to determine if and how the messages are relayed to the user's mobile device 100. The message management server 272 may also compress and encrypt new messages (e.g. using an encryption technique such as Data Encryption Standard (DES), Triple DES, or Advanced Encryption Standard (AES)) and push them to the mobile device 100 via the shared network infrastructure 224 and the wireless network 200. The message management server 272 may also receive messages composed on the mobile device 100 (e.g. encrypted using Triple DES), decrypt and decompress the composed messages, re-format the composed messages if desired so that they will appear to have originated from the user's computer 262a, and re-route the composed messages to the message server 268 for delivery.

Certain properties or restrictions associated with messages that are to be sent from and/or received by the mobile device 100 can be defined (e.g. by an administrator in accordance with IT policy) and enforced by the message management server 272. These may include whether the mobile device 100 may receive encrypted and/or signed messages, minimum encryption key sizes, whether outgoing messages must be encrypted and/or signed, and whether copies of all secure messages sent from the mobile device 100 are to be sent to a pre-defined copy address, for example.

The message management server 272 may also be adapted to provide other control functions, such as only pushing certain message information or pre-defined portions (e.g. “blocks”) of a message stored on the message server 268 to the mobile device 100. For example, in some cases, when a message is initially retrieved by the mobile device 100 from the message server 268, the message management server 272 may push only the first part of a message to the mobile device 100, with the part being of a pre-defined size (e.g. 2 KB). The user can then request that more of the message be delivered in similar-sized blocks by the message management server 272 to the mobile device 100, possibly up to a maximum pre-defined message size. Accordingly, the message management server 272 facilitates better control over the type of data and the amount of data that is communicated to the mobile device 100, and can help to minimize potential waste of bandwidth or other resources.

The mobile data server 274 encompasses any other server that stores information that is relevant to the corporation. The mobile data server 274 may include, but is not limited to, databases, online data document repositories, customer relationship management (CRM) systems, or enterprise resource planning (ERP) applications.

The contact server 276 can provide information for a list of contacts for the user in a similar fashion as the address book on the mobile device 100. Accordingly, for a given contact, the contact server 276 can include the name, phone number, work address and e-mail address of the contact, among other information. The contact server 276 can also provide a global address list that contains the contact information for all of the contacts associated with the host system 250.

It will be understood by persons skilled in the art that the message management server 272, the mobile data server 274, the contact server 276, the device manager module 278, the data store 284 and the IT policy server 286 do not need to be implemented on separate physical servers within the host system 250. For example, some or all of the functions associated with the message management server 272 may be integrated with the message server 268, or some other server in the host system 250. Alternatively, the host system 250 may comprise multiple message management servers 272, particularly in variant implementations where a large number of mobile devices need to be supported.

Alternatively, in some example embodiments, the IT policy server 286 can provide the IT policy editor 280, the IT user property editor 282 and the data store 284. In some cases, the IT policy server 286 can also provide the device manager module 278. The processor 288 of the IT policy server 286 can be used to perform the various steps of a method for providing IT policy data that is customizable on a per-user basis. The processor 288 can execute the editors 280 and 282. In some cases, the functionality of the editors 280 and 282 can be provided by a single editor. In some cases, the memory unit 292 can provide the data store 284.

The device manager module 278 provides an IT administrator with a graphical user interface with which the IT administrator interacts to configure various settings for the mobile devices 100. As mentioned, the IT administrator can use IT policy rules to define behaviors of certain applications on the mobile device 100 that are permitted such as phone, web browser or Instant Messenger use. The IT policy rules can also be used to set specific values for configuration settings that an organization requires on the mobile devices 100 such as auto signature text, WLAN/VoIP/VPN configuration, security requirements (e.g. encryption algorithms, password rules, etc.), specifying themes or applications that are allowed to run on the mobile device 100, and the like.

### Exemplary Application Listing

```
<ac:updateInterval>7</ac:updateInterval> - listing update interval in days.
<ac:version>1.0.0.26</ac:version> - application version.
<ac:vendor>Research In Motion Ltd.</ac:vendor> - application vendor
<ac:size>69000</ac:size> - application size
<ac:iconURL>/icons/1212644020799icon.png</ac:iconURL> - application
ICON URL
<ac:imageURL>/images/1212418909630Spb_Wallet_2000.jpg</ac:imageURL> -
application image URL
<ac:infoURL>http://www.rim.com/info</ac:infoURL> - optional, application info URL
<ac:mandatory>true</ac:mandatory > - optional, mandatory application
<ac:wap>true</ac:wap> - optional, download through WAP protocol
<ac:rimvalueAddedApp>true</ac:rimvalueAddedApp > - optional, RIM value added
application
<?xml version=“1.0” encoding=“UTF-8”?>
<feed xmlns=“http://www.w3.org/2005/Atom” xmlns:dc=“http://purl.org/dc/elements/1.1/”
xmlns:sy=“http://purl.org/rss/1.0/modules/syndication/”
xmlns:taxo=“http://purl.org/rss/1.0/modules/taxonomy/”
xmlns:ac=“http://www.rim.net/appcenter/directory/1.0”
xmlns:rdf=“http://www.w3.org/1999/02/22-rdf-syntax-ns#”>
  <title>Application Listing for Research In Motion Ltd. BlackBerry 9000 devices with OS
4.6.0</title>
  <link rel=“alternate” href=“http://www.blackberry.com” />
  <subtitle>This is the directory of applications available for BlackBerry 9000 devices
from Research In Motion Ltd.. Supporting OS version: 4.6.0</subtitle>
  <ac:updateInterval>7</ac:updateInterval>
  <entry>
  <title>Wallet</title>
  <link rel=“alternate” href=“http://mds03-vmyyz/rimapp/wallet/4.2.1/wallet.jad” />
  <author>
    <name />
  </author>
  <summary type=“TEXT”>Wallet</summary>
  <ac:version>1.0.0.26</ac:version>
  <ac:vendor>Research In Motion Ltd.</ac:vendor>
  <ac:size>69000</ac:size>
  <ac:iconURL>/icons/1212644020799icon.png</ac:iconURL>
    <ac:imageURL>/images/1212418909630Spb_Wallet_2000.jpg</ac:imageURL>
    <ac:wap>true</ac:wap>
  </entry>
  <entry>
  <title>Ecommerce Content Optimization Engine</title>
  <link rel=“alternate” href=“http://mds03-vmyyz/rimapp/ecoe/4.2.1/ecoe.jad” />
  <author>
    <name />
  </author>
  <summary type=“TEXT” />
  <ac:version>1.0.0.27</ac:version>
  <ac:vendor>Research In Motion Ltd.</ac:vendor>
  <ac:size>64000</ac:size>
  <ac:iconURL>/icons/1212417757603icon.png</ac:iconURL>
    <ac:imageURL>/images/1212417700411rim-logo.jpg</ac:imageURL>
    <ac:rimvalueAddedApp>true</ac:rimvalueAddedApp>
  </entry>
  <entry>
  <title>Facebook</title>
  <link rel=“alternate” href=“http://mds03-
vmyyz/rimapp/facebook/For_4.6.0/net_rim_bb_facebook.jad” />
  <author>
    <name />
  </author>
  <summary type=“TEXT”>Facebook</summary>
  <ac:version>1.2.9</ac:version>
  <ac:vendor>Research In Motion Limited</ac:vendor>
  <ac:size>244000</ac:size>
  <ac:iconURL>/icons/1212418001460icon.png</ac:iconURL>
  <ac:imageURL>/images/1212418001460facebook-icon.gif</ac:imageURL>
  </entry>
  <entry>
  <title>Windows Live Messenger</title>
  <link rel=“alternate” href=“http://mds03-
vmyyz/rimapp/msn/For_4.6.0/msn_460_en.jad” />
  <author>
    <name />
  </author>
  <summary type=“TEXT”>Windows Live Messenger</summary>
  <ac:version>2.1.18</ac:version>
  <ac:vendor>Research In Motion Limited</ac:vendor>
  <ac:size>343000</ac:size>
  <ac:iconURL>/icons/1212418571991icon.png</ac:iconURL>
    <ac:imageURL>/images/1212418571991msn_messenger_logo.jpg</ac:imageURL>
    <ac:mandatory>true</ac:mandatory>
  </entry>
  <entry>
  <title>BlackBerry Client for Lotus Connections</title>
  <link rel=“alternate” href=“http://mds03-
vmyyz/rimapp/connections/For_4.2.1/Connections.jad” />
  <author>
    <name />
  </author>
  <summary type=“TEXT”>BlackBerry Client for Lotus Connections</summary>
  <ac:version>1.0.0</ac:version>
  <ac:vendor>Research In Motion Limited</ac:vendor>
  <ac:size>73000</ac:size>
  <ac:iconURL>/icons/1212417492293icon.png</ac:iconURL>
  <ac:imageURL>/images/1212417492152connections-logo108.png</ac:imageURL>
  </entry>
  <entry>
  <title>Yahoo! Messenger</title>
  <link rel=“alternate” href=“http://mds03-
vmyyz/rimapp/yahoo/For_4.6.0/yahoo_460_en.jad” />
  <author>
    <name />
  </author>
  <summary type=“TEXT”>Yahoo! Messenger</summary>
  <ac:version>2.1.18</ac:version>
  <ac:vendor>Research In Motion</ac:vendor>
  <ac:size>359000</ac:size>
  <ac:iconURL>/icons/1212438030751icon.png</ac:iconURL>
  <ac:imageURL>/images/1212438030720t_Yahoo_Messenger_.jpg</ac:imageURL>
  </entry>
  <entry>
  <title>AOL Instant Messenger</title>
  <link rel=“alternate” href=“http://mds03-vmyyz/rimapp/aim/For_4.6.0/aim_460_en.jad” />
  <author>
    <name />
  </author>
  <summary type=“TEXT”>AOL Instant Messenger</summary>
  <ac:version>2.1.18</ac:version>
  <ac:vendor>Research In Motion Limited</ac:vendor>
  <ac:size>279000</ac:size>
  <ac:iconURL>/icons/1212416553842icon.png</ac:iconURL>
  <ac:imageURL>/images/1212416604719549.JPG</ac:imageURL>
  </entry>
  <entry>
  <title>Word Press</title>
  <link rel=“alternate” href=“http://mds03-
vmyyz/rimapp/wordpress/For_4.2.0/net_rim_bb_wordpress.jad” />
  <author>
    <name />
  </author>
  <summary type=“TEXT”>Word Press</summary>
  <ac:version>1.0.3</ac:version>
  <ac:vendor>Research In Motion Limited</ac:vendor>
  <ac:size>58000</ac:size>
  <ac:iconURL>/icons/1212419103075icon.png</ac:iconURL>
  <ac:imageURL>/images/1212419102997wordpress-logo-cristal.jpg</ac:imageURL>
  </entry>
  <entry>
  <title>Picasa</title>
  <link rel=“alternate” href=“http://mds03-
vmyyz/rimapp/picasa/For_4.2.0/net_rim_bb_picasa.jad” />
  <author>
    <name />
  </author>
  <summary type=“TEXT”>Picasa</summary>
  <ac:version>1.0.0</ac:version>
  <ac:vendor>Research In Motion Limited</ac:vendor>
  <ac:size>0</ac:size>
  <ac:iconURL>/icons/1212418766281icon.png</ac:iconURL>
  <ac:imageURL>/images/1212418766281icon.png</ac:imageURL>
  </entry>
  <entry>
  <title>ICQ</title>
  <link rel=“alternate” href=“http://mds03-vmyyz/rimapp/icq/For_4.2.0/icq_420_en.jad” />
  <author>
    <name />
  </author>
  <summary type=“TEXT”>ICQ</summary>
  <ac:version>2.1.18</ac:version>
  <ac:vendor>Research In Motion Limited</ac:vendor>
  <ac:size>284000</ac:size>
  <ac:iconURL>/icons/1212418418541icon.png</ac:iconURL>
  <ac:imageURL>/images/1212418418541icq_logo.gif</ac:imageURL>
  </entry>
  <entry>
  <title>Google Talk</title>
  <link rel=“alternate” href=“http://mds03-
vmyyz/rimapp/google/For_4.6.0/google_460_en.jad” />
  <author>
    <name />
  </author>
  <summary type=“TEXT”>Google Talk</summary>
  <ac:version>2.1.18</ac:version>
  <ac:vendor>Research In Motion Limited</ac:vendor>
  <ac:size>29900</ac:size>
  <ac:iconURL>/icons/1212418216007icon.png</ac:iconURL>
  <ac:imageURL>/images/1212418215866Google_Talk_(logo).jpg</ac:imageURL>
  </entry>
</feed>
```

Many modifications and other example embodiments will come to the mind of one skilled in the art having the benefit of the teachings presented in the foregoing descriptions and the associated drawings. Therefore, it is understood that the invention is not to be limited to the specific example embodiments disclosed, and that modifications and example embodiments are intended to be included.

That which is claimed is:

1. A mobile wireless communications system comprising:
at least one mobile wireless communications device configured to wirelessly communicate via a carrier network;
at least one application storage server configured to store a plurality of mobile device applications for use by the at least one mobile wireless communications device; and
an application catalog server configured to
provide an interface for uploading at least one mobile device application identification file from the carrier network identifying approved mobile device applications,
generate a list of the approved mobile device applications to be presented on said at least one mobile wireless communications device based upon the at least one mobile device application identification file, and
direct said at least one mobile wireless communications device to said at least one application storage server to download and install a mobile device application selected from the list of approved mobile device applications.

2. The mobile wireless communications system of claim 1 wherein the interface is also for permitting modification of the at least one mobile device application identification file by the carrier network.

3. The mobile wireless communications system of claim 1 wherein said at least one mobile wireless communications device comprises a plurality thereof having respective device types; and wherein said application catalog server is configured to generate different lists of approved mobile device applications for respective mobile wireless communications device types.

4. The mobile wireless communications system of claim 1 wherein said at least one mobile wireless communications device is configured to generate an installation report upon installation of the selected mobile device application; and wherein said application catalog server is configured to collect the installation report.

5. The mobile wireless communications system of claim 1 wherein the at least one application identification file comprises an extensible markup language (XML) file.

6. The mobile wireless communications system of claim 1 wherein the list of the approved mobile device applications comprises a Really Simple Syndication (RSS) formatted list comprising a plurality of application descriptors.

7. The mobile wireless communications system of claim 6 wherein the application descriptors comprise at least one of an application name, version, vendor, description, and size.

8. An application catalog server for use with at least one mobile wireless communications device configured to wirelessly communicate via a carrier network and at least one application storage server configured to store a plurality of mobile device applications for use by the at least one mobile wireless communications device, the application catalog server comprising:
an interface module configured to provide an interface for uploading at least one mobile device application identification file from the carrier network identifying approved mobile device applications; and
a processing module configured to
generate a list of the approved mobile device applications to be presented on the at least one mobile wireless communications device based upon the at least one mobile device application identification file, and
direct the at least one mobile wireless communications device to the at least one application storage server to download and install a mobile device application selected from the list of approved mobile device applications.

9. The application catalog server of claim 8 wherein the interface is also for permitting modification of the at least one mobile device application identification file by the carrier network.

10. The application catalog server of claim 8 wherein the at least one mobile wireless communications device comprises a plurality thereof having respective device types; and wherein said processing module is configured to generate different lists of approved mobile device applications for respective mobile wireless communications device types.

11. The application catalog server of claim 8 wherein the at least one mobile wireless communications device is configured to generate an installation report upon installation of the selected mobile device application; and wherein said processing module is configured to collect the installation report.

12. The application catalog server of claim 8 wherein the at least one application identification file comprises an extensible markup language (XML) file.

13. A mobile wireless communications method comprising:
providing at least one mobile wireless communications device configured to wirelessly communicate via a carrier network;
storing a plurality of mobile device applications for use by the at least one mobile wireless communications device on at least one application storage server; and
at an application catalog server,
providing an interface for uploading at least one mobile device application identification file from the carrier network identifying approved mobile device applications,
generating a list of the approved mobile device applications to be presented on the at least one mobile wireless communications device based upon the at least one mobile device application identification file, and
directing the at least one mobile wireless communications device to the at least one application storage server to download and install a mobile device application selected from the list of approved mobile device applications.

14. The method of claim 13 wherein the interface is also for permitting modification of the at least one mobile device application identification file by the carrier network.

15. The method of claim 13 wherein the at least one mobile wireless communications device comprises a plurality thereof having respective device types; and further comprising generating different lists of approved mobile device applications for respective mobile wireless communications device types at the application catalog server.

16. The method of claim 13 wherein the at least one mobile wireless communications device is configured to generate an installation report upon installation of the selected mobile device application; and further comprising collecting the installation report at the application catalog server.

17. The method of claim 13 wherein the at least one application identification file comprises an extensible markup language (XML) file.

18. A physical computer-readable medium for use with at least one mobile wireless communications device configured to wirelessly communicate via a carrier network and at least one application storage server configured to store a plurality of mobile device applications for use by the at least one mobile wireless communications device, the physical computer-readable medium comprising:
an interface module configured to provide an interface for uploading at least one mobile device application identification file from the carrier network identifying approved mobile device applications; and
a processing module configured to
generate a list of the approved mobile device applications to be presented on the at least one mobile wireless communications device based upon the at least one mobile device application identification file, and
direct the at least one mobile wireless communications device to the at least one application storage server to download and install a mobile device application selected from the list of approved mobile device applications.

19. The physical computer-readable medium of claim 18 wherein the interface is also for permitting modification of the at least one mobile device application identification file by the carrier network.

20. The physical computer-readable medium of claim 18 wherein the at least one mobile wireless communications device comprises a plurality thereof having respective device types; and wherein said processing module is configured to generate different lists of approved mobile device applications for respective mobile wireless communications device types.

21. The physical computer-readable medium of claim 18 wherein said at least one mobile wireless communications device is configured to generate an installation report upon installation of the selected mobile device application; and wherein said processing module is configured to collect the installation report.

22. The physical computer-readable medium of claim 18 wherein the at least one application identification file comprises an extensible markup language (XML) file.
